(19) United States
(12) Patent Application Publication
(10) Pub. No.: US 2009/0282265 A1
(43) Pub. Date: Nov. 12, 2009

(54) METHOD AND APPARATUS FOR PREVENTING ACCESS TO ENCRYPTED DATA IN A NODE

(76) Inventors: Selim Aissi, Beaverton, OR (US); Gyan Prakash, Beaverton, OR (US); Jasmeet Chhabra, Hillsboro, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/116,743

(22) Filed: May 7, 2008

(51) Int. Cl. G06F 21/00

(52) U.S. Cl. 713/193

(57) ABSTRACT

A method of preventing access of data in a node quickly and securely when the node is lost or stolen. The data is first encrypted using an encryption algorithm with a cryptographic key-material. Heuristic methods of detecting un-authorized access to the node are implemented to generate a theft-trigger. The theft-trigger is received and sent to a central authority. The validity of the trigger is verified and the central authority sends an acknowledgement of the trigger. When approval is given from the central authority, access to the data is prevented by deleting or concealing some cryptographic key-material.

### BACKGROUND

1. Field

This invention relates to the field of cryptography and more specifically but not exclusively, to prevent access to encrypted data stored in a node.

2. Background Description

Owners of devices such as laptops, mobile phones, desktops, servers, and personal digital assistants (PDAs) for example, are increasingly concerned when their devices are lost or stolen as their confidential information stored in the devices can be accessed easily if the information is not protected. For corporate users especially, the data may be more valuable than the value of the devices and hence data protection is very important. Sensitive company information can be misused if it is placed in the wrong hands.

In some cases, the device's owner or the Enterprise's Information Technology (IT) policies dictate that data on the device becomes unrecoverable when such device is lost or stolen. One possible example may be the case of an employee of a financial institution who wants to ensure that the data on his device is unrecoverable when the device is lost or stolen.

There are several methods known in the art to make the data unrecoverable. One method of file wiping or file shredding is to overwrite the data stored in a mass-storage device such as a hard disk, or flash memory etc with a pattern of all zeros, all ones, or an alternating pattern of ones and zeros. However, overwriting a mass storage device is a slow process and in the event of a device-theft, the data may be retrieved before the mass storage device is completely wiped out. Another method of making the data unrecoverable is to use a degausser. The degausser removes or reduces the magnetic field and when applied to magnetic media such as a hard disk, the contents may be wiped out. However, for a case of device-theft, there is no way of degaussing the mass storage device as the device is irretrievable.

There is a need for a method to ensure data in a mobile device can be shredded quickly and securely when the device is lost or stolen.

### BRIEF DESCRIPTION OF THE DRAWINGS

The features and advantages of embodiments of the invention matter will become apparent from the following detailed description of the subject matter in which:

FIG. 1 shows one embodiment of a node connected with a central authority via multiple communication paths;

FIG. 2 illustrates the hardware in the node in accordance with an embodiment of the invention;

FIG. 3 illustrates the modules in the node in accordance with an embodiment of the invention;

FIG. 4 is a flowchart according to an embodiment of the invention;

FIG. 5 is a flowchart according to an embodiment of the invention;

FIG. 6 is a flowchart according to an embodiment of the invention;

FIG. 7A is a flowchart according to an embodiment of the invention; and

FIG. 7B is a flowchart according to an embodiment of the invention.

### DETAILED DESCRIPTION

Reference in the specification to “one embodiment” or “an embodiment” of the invention means that a particular feature, structure or characteristic described in connection with the embodiment is included in at least one embodiment of the invention. Thus, the appearances of the phrase “in one embodiment” appearing in various places throughout the specification are not necessarily all referring to the same embodiment.

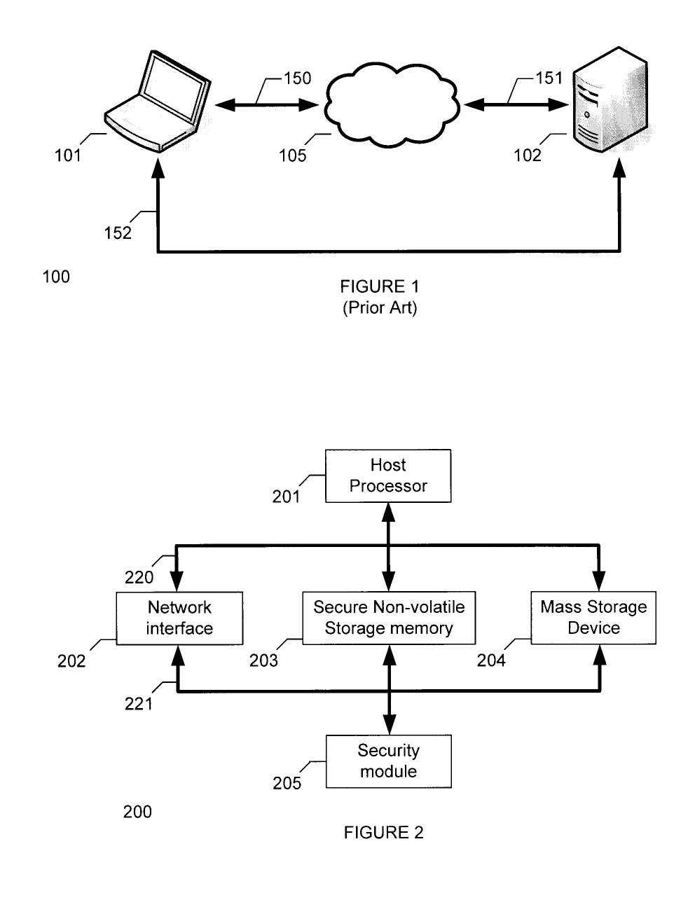

Embodiments of the invention ensure that the data in a device is shredded quickly and securely when the device is lost or stolen. This is explained clearly in the following figures. FIG. 1 illustrates a prior art network arrangement 100 of a node 101 connected with a central authority 102. The node includes, but is not limited to, a laptop, a personal digital assistant, a mobile phone, a smart phone, a Personal Computer (PC), a tablet PC, or any device that has a mass storage device. The central authority 102 includes, but is not limited to, a server, a PC, a laptop, or any device that is able to communicate and authenticate with the node. The central authority 102 has a policy setting to instruct the node 101 on how to prevent access to its data when the node 101 is stolen or lost.

The node 101 communicates directly using a communication link 152 with the central authority 102. The node 101 also communicates via an intermediate node 105 with the central authority 102 using communication links 150 and 151. The communication links 150, 151, and 152 include, but are not limited to, Ethernet, Institute of Electrical and Electronic Engineers (IEEE) 802 wireless standard family, Bluetooth, Ultra Wide Band (UWB), Global System for Mobile communications (GSM), or any wired or wireless communication protocol. The intermediate node 105 includes, but is not limited to, the Internet, a Local Area Network (LAN), a Wide Area Network (WAN), a router, a switch, or any hardware or network that allows the node 101 to communicate with the central authority 102. Although only one node 101 and one central authority 102 are illustrated, the invention may include any number of nodes and central authorities.

FIG. 2 illustrates the hardware 200 in the node 101 according to one embodiment of the invention. The illustration is not meant to be limiting and the node 101 may include more components without affecting the workings of the invention. The node 101 includes a host processor 201, a network interface 202, a secure non volatile storage memory 203, a mass storage device 204 and a security module 205. The host processor 201 communicates with the network interface 202, with the secure non-volatile storage memory 203, and with the mass storage device 204 using the communication link 220. The network interface 202 establishes the communication links 150 and 152 between the node 101 and the central authority 102. The mass storage device 204 includes, but is not limited to, an internal or external magnetic hard disk, a flash based memory, or any storage medium that can be connected with the node 101. To protect their data, the user of the node 101 encrypts a partition, a folder, a file or the entire mass storage device 204 using an encryption algorithm. The encryption algorithm includes, but is not limited to, Advanced Encryption Standard (AES), Data Encryption Standard (DES), Triple Data Encryption Standard (3DES), International Data Encryption Algorithm (IDEA), Blowfish, RSA, RC4, or any other data-encryption algorithm.

The security module 205 enables the encrypted data in the node 101 to be shredded quickly and securely when the device is lost or stolen. It has independent access to the network interface 202, to the secure non volatile storage memory 203, and to the mass storage device 204 using the communication link 221. The security module 205 is made independent of the host processor 201 to secure it from hardware and software attacks. Malicious software like Trojans, viruses, for example, can infect the host operating system, but not the security module 205 as it is inaccessible by the host processor 201. The communication links 220 and 221 include at least one communication protocol, but are not limited to, Peripheral Component Interconnect (PCI), PCI Extended (PCI-X), Integrated Drive Electronics (IDE), Serial Advanced Technology Attachment), Universal Serial Bus (USB), Serial Peripheral Interface (SPI), Inter-Integrated Circuit (I2C), or any other wired or wireless communication protocol. The security module 205 includes but is not limited to, a chipset, a processor, or any computing device that can execute instructions.

The secure non-volatile storage memory 203 stores cryptographic key-material required by the encryption and decryption algorithm used by the user for encrypting and decrypting the data. The cryptographic key-material stored in the secure non-volatile storage memory 203 includes, but is not limited to, an encryption key, an decryption key, a nonce, a pass phrase, or any other information that is required for the encryption and decryption of the data. The secure non-volatile storage memory 203 includes, but is not limited to, a secure Electrically Erasable Programmable Read-Only Memory (EEPROM), a secure flash memory, or any other types of secure non-volatile storage memory. The secure non-volatile storage memory 203 transfers information securely with the security module 205 and the host processor 201. It does not transfer any cryptographic key-material in clear text. In one embodiment of the invention, the secure non-volatile storage memory 203 is a part of the security module 205. In another embodiment of the invention, the secure non-volatile storage memory 203 is a part of the host processor 201. In another embodiment of the invention, the security module is a part of the host processor 201.

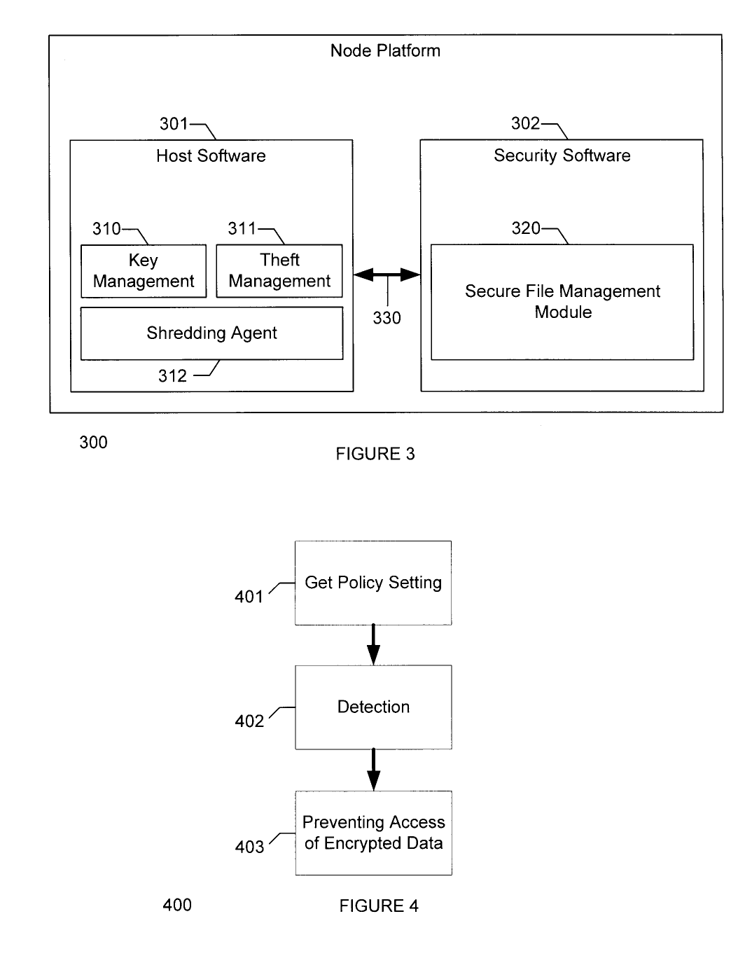

FIG. 3 shows the modules in the node platform 300 according to one embodiment of the invention. The node platform 300 has a host software 301 and a security software 302. The host software 301 has three modules that execute on the host operating system. The first module is the key management module 310. It manages the storage of cryptographic key-material in the secure non-volatile storage memory 203 that is used during the encryption and decryption of data. The second module is the theft management module 311. The theft management module 311 monitors the theft status of the node. The theft status has at least two states: normal and stolen state. The theft management module 311 also detects two types of triggers: local triggers that indicate suspicious activity performed on the node 101 and remote triggers from a central authority 102. Heuristic methods are implemented in the node 101 to generate autonomously a local trigger when suspicious behavior is observed. One heuristic method is to monitor the number of unsuccessful login attempts to the node 101. If the number of unsuccessful login attempts exceeds a certain threshold, the theft management module 311 generates a local trigger. Another heuristic method is to set a timer that runs for a configurable interval. When the node 101 communicates with the central authority 102, the theft management module 311 resets and restarts the timer. However, when the node 101 fails to communicate with the central authority 102 within the configured interval, the timer expires and theft management module 311 generates a local trigger. Other heuristic methods include, but are not limited to, generating a local trigger, when the basic input-output system (BIOS) of the node is tampered, when the secure non-volatile storage memory 203 is removed or tampered, when the security software 302 is tampered, or any other heuristic methods that may indicate that the node 101 is stolen or lost.

Remote triggers are supported by service providers for users of the node 101 to report theft or loss. A trigger is sent from the central authority 102 to the node 101 to initiate preventing access to the data. Another possible use of this feature is when the node 101 is to be transferred from one user to another user. The data in the node 101 is shredded conveniently by preventing access to the data. The new user cannot access the original data in the node 101 but the new user is able to use the node 101 to create new data. This saves time of using the method of overwriting or formatting the mass storage device 204.

When local or remote triggers are generated, the triggers are sent from the theft management module 311 to the secure file management module 320 in the security software 302 using the communication link 330. The security software 302 is executed on the security module 201. The secure file management module 320 is independent of the host software. In one embodiment of the invention, it is executed at all times, including when the node 101 is powered off. It communicates with the central authority 102 using the network interface 202 when a trigger is received from the theft management module 311. When it receives the approval from the central authority 102 to initiate preventing access to the data, the shredding agent 312 in the host software 301 is notified to start the prevention. Detailed workings of the invention are described in the following figures.

The shredding agent 312 is the third module in the host software 301. It accesses the cryptographic key-material stored in the non volatile storage memory 203. When it receives the notification from the secure file management module 320, it prevents access to the encrypted data stored in the node 101. There are two ways of preventing access to the encrypted data: Temporary prevention and permanent prevention. In one embodiment, permanent prevention of access to the encrypted data is achieved by deleting the cryptographic key-material. Once the cryptographic key-material is deleted by overwriting with all zeros, all ones or an alternating pattern of zeros and ones, the encrypted data cannot be decrypted. In another embodiment, temporary prevention of access to the encrypted data is achieved by hiding the cryptographic key-material. The cryptographic key-material is hidden by encryption and or by wrapping it with another cryptographic key. Other methods of preventing access to the encrypted data in the node 101 include, but are not limited to, disable the node from booting and other methods of preventing access to the encrypted data.

Although the host software 301 is described with three modules, it is not meant to be limiting and the invention can be implemented with any combination of the modules. In addition, the host software 301 and security software 302 can be implemented in hardware, firmware, software or a combination of hardware, firmware and software. In another embodiment of the invention, the security software 302 is combined with the host software 301 and the secure file management module 320 is executed on the host software.

FIG. 4 shows the process in a flowchart 400 according to one embodiment of the invention. In step 401, the policy setting from the central authority 102 is obtained. The policy is a rule that designates the method for preventing access to the encrypted data in the node 101 when theft of the node 101 is established. In step 402, the node 101 starts detection and communicates with the central authority 102 when it detects possible suspicious activity. In step 403, the prevention of access to the encrypted data is done in accordance with the policy setting in the central authority 102 in step 401. In describing these steps, it is assumed that the user has already determined the data to be protected in the node 101 and the data is encrypted using an encryption algorithm. In addition, the encryption and decryption keys are stored in the secure non-volatile storage memory 203 by the key management module 310. The following figures explain each step in greater detail.

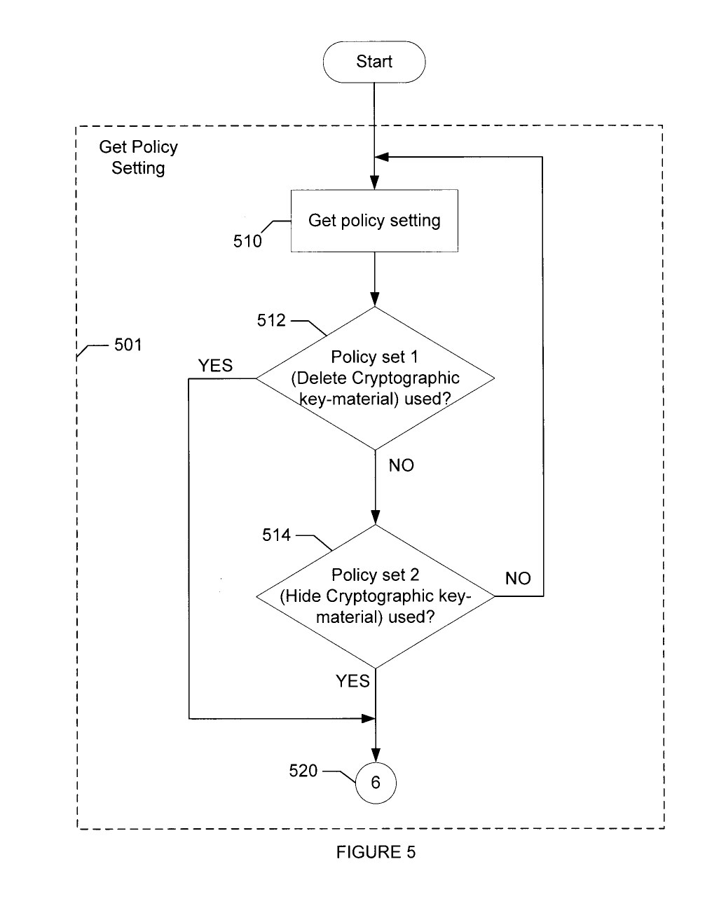

FIG. 5 shows a detail process 501 of the step 401. In this embodiment of the invention, only two cases of policy settings are considered. However, it is not meant to be limiting and many other policy settings can be implemented. In step 510, the secure file management module 320 gets the policy setting from the central authority 102 via the network interface 202. In step 512, the flow checks if policy set 1 of deleting the cryptographic key-material is used. If yes, it goes to flow 6 in step 520. If not, step 514 checks if policy set 2 of hiding the cryptographic key-material is used. If yes, it also goes to flow 6 in step 520. If not, the flow goes back to step 510 of getting the policy information.

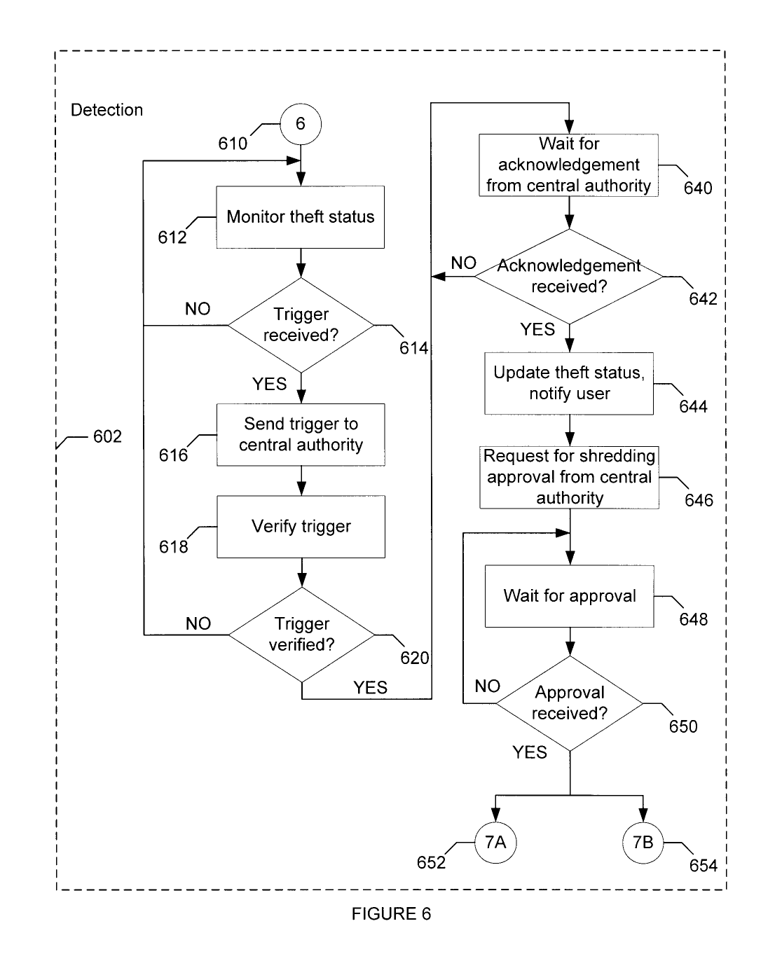

FIG. 6 shows a detail process 602 of the step 402. The theft status of the node 101 is monitored by the theft management module 311 in step 612. Step 614 checks when a local or remote trigger as described earlier is received. If yes, the theft management module 311 sends the received trigger to the secure file management module 320. If not, the flow goes back to step 612 to continue monitoring the theft status. In step 616, the secure file management module 320 sends the received trigger to the central authority 102 using the network interface 202. The secure file management module 320 verifies the authenticity of the trigger in step 618. If the trigger is verified as valid in step 620, the flow goes to step 640. If not, the flow goes back to step 612 to continue monitoring the theft status. In step 640, the secure file management module 320 waits for the acknowledgement from the central authority 102. Step 642 checks when the acknowledgement is received. If the acknowledgement is not received, the flow continues to wait in step 640. When the acknowledgement is received, the secure file management module 320 updates the theft status in the theft management module 311 to a stolen state and notifies the user in step 644. The secure file management module 320 sends a request to the central authority 102 to prevent access to the encrypted data. In step 650, the secure file management module 320 waits for the approval from the central authority 102. Step 650 checks when the approval is received. If the approval is not received, the flow continues to wait in step 648. When the approval is received, the secure file management module 320 follows the next step in the flow 400. For policy set 1 as described earlier, the flow continues to flow 7A in step 652. For policy set 2 as described earlier, the flow continues to flow 7B in step 654.

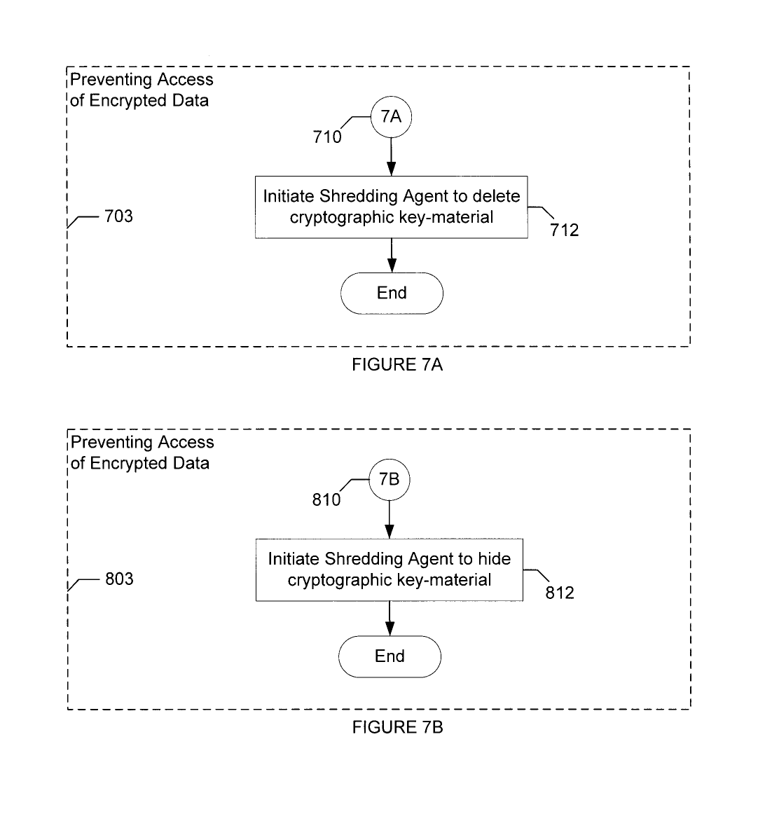

FIG. 7A shows a detail process 703 of the step 403. Flow 7A is followed for policy set 1 of deleting the cryptographic key-material. In step 712, the secure file management module 320 initiates the shredding agent 312 to delete the cryptographic key-material stored in the non-volatile storage memory 203. When the deletion is completed, the shredding agent informs the secure file management module 320. In one embodiment of the invention, the secure file management module 320 sends a notification to the central authority 102 if the trigger is generated remotely by the central authority.

FIG. 7B shows a detail process 803 of the step 403. Path 7B is followed for policy set 2 of hiding the cryptographic key-material. In step 812, the secure file management module 320 initiates the shredding agent 312 to hide the cryptographic key-material stored in the non-volatile storage memory 203. When the hiding is completed, the shredding agent informs the secure file management module 320. In one embodiment of the invention, the secure file management module 320 sends a notification to the central authority 102 if the trigger is generated remotely by the central authority.

Although examples of the embodiments of the disclosed subject matter are described with reference to block and flow diagrams in FIGS. 1-6, 7A and 7B, one of ordinary skill in the relevant art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the relevant art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the relevant art may appreciate that embodiments of the disclosed subject matter can be practiced with various computer network configurations, including multiple servers or clients and multiple wired or wireless communication paths. Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skill in the art to which the disclosed subject matter pertains are deemed to lie within the scope of the disclosed subject matter.

What is claimed is:

1. A method of preventing access to data in a node, wherein the data is encrypted using an encryption algorithm with a cryptographic key-material, comprising:
receiving a trigger, wherein the trigger indicates suspicious activity performed on the node or indicates theft of the node;
sending the trigger to a central authority, wherein the central authority has a policy setting for preventing access to the encrypted data;
receiving an acknowledgement of the trigger from the central authority;
verifying the validity of the trigger;
updating a theft status of the node when the trigger is verified;
requesting an approval from the central authority for preventing access to the encrypted data after updating the theft status;
receiving the approval from the central authority; and
preventing access to the encrypted data based on the policy setting, responsive to receiving the approval.

2. The method in claim 1 further comprising obtaining the policy setting from the central authority.

3. The method in claim 1, wherein preventing access to the encrypted data comprises:
deleting the cryptographic key-material or concealing the cryptographic key-material.

4. The method in claim 1, wherein requesting the approval comprises:
notifying an authorized user of the node before preventing access to the encrypted data.

5. The method in claim 1 further comprising storing the cryptographic key-material in a secure non-volatile storage memory.

6. The method in claim 1, wherein receiving the trigger comprises:
implementing at least one heuristic method of detecting unauthorized activity in the node.

7. The method in claim 6, wherein the heuristic method comprises:
monitoring a number of unsuccessful login attempts to the node; and
generating the trigger when the number of unsuccessful login attempts exceeds a threshold.

8. The method in claim 6, wherein the heuristic method comprises:
setting a timer that runs for a configurable interval in the node;
resetting and restarting the timer when contact is maintained between the node and the central authority; and
generating the trigger by the node when the timer expires.

9. A node comprising:
a mass storage device having data encrypted using an encryption algorithm with a cryptographic key-material;
a host processor having an Operating System (OS) executing on the host processor, wherein the OS comprises:
a key management module, to manage the storage of the cryptographic key-material;
a theft management module, to monitor a theft status and to detect a trigger, wherein the trigger indicates suspicious activity performed on the node or indicates theft of the node;
a shredding agent, to prevent access to the encrypted data; and
a Secure File Shredding Management (SFSM) module to:
receive the trigger;
send the trigger to a central authority, wherein the central authority has a policy setting for preventing access to the encrypted data;
receive an acknowledgement of the trigger from the central authority;
verify the validity of the trigger;
update the theft status of the node when the trigger is verified;
request an approval from the central authority for preventing access to the encrypted data after updating the theft status;
receive the approval from the central authority; and
initiate the shredding agent to prevent access to the encrypted data based on the policy setting, responsive to receiving the approval.

10. The node of claim 9, wherein the OS is a first OS, the node further comprising:
a security module having a second OS executing on the security module, wherein the SFSM module runs on the second OS.

11. The shredding agent in claim 9, wherein preventing access to the encrypted data is to:
delete the cryptographic key-material or to conceal the cryptographic key-material.

12. The node in claim 9, wherein the SFSM module is to:
notify an authorized user of the node before preventing access to the encrypted data.

13. The node in claim 9, wherein the SFSM module is further to obtain the policy setting from the central authority.

14. The node in claim 9, wherein the key management module is to:
store the cryptographic key-material in a secure non-volatile storage memory.

15. The node in claim 9, wherein the theft management module is to:
implement at least one heuristic method of detecting unauthorized activity in the node.

16. The theft management module in claim 15, wherein the heuristic method is to:
monitor a number of unsuccessful login attempts to the node; and
generate the trigger when the number of unsuccessful login attempts exceeds a threshold.

17. The theft management module in claim 15, wherein the heuristic method is to:
set a timer that runs for a configurable interval in the node;
reset and restart the timer when contact is maintained between the node and the central authority; and
generate the trigger when the timer expires.

18. The node in claim 9, wherein the theft management module is to:
send the trigger to the SFSM module when the trigger is received.

19. A computer readable medium having instructions stored thereon which, when executed in a node, cause a host processor, having data encrypted using an encryption algorithm with a cryptographic key-material, and a security module, to perform the following steps:
receiving a trigger, wherein the trigger indicates suspicious activity performed on the node or indicates theft of the node;
sending the trigger to a central authority, wherein the central authority has a policy setting for preventing access to the encrypted data;
verifying the validity of the trigger;
receiving an acknowledgement of the trigger from the central authority;
updating a theft status of the node when the trigger is verified;
requesting an approval from the central authority for preventing access to the encrypted data after updating the theft status;
receiving the approval from the central authority; and
preventing access to the encrypted data based on the policy setting, responsive to receiving the approval.

20. The medium in claim 19 further comprising obtaining the policy setting from the central authority.

21. The medium in claim 19, wherein preventing access to the encrypted data comprises:
deleting the cryptographic key-material or concealing the cryptographic key-material.

22. The medium in claim 19, wherein requesting the approval comprises:
notifying an authorized user of the node before preventing access of the encrypted data.

23. The medium in claim 19 further comprising storing the cryptographic key-material in a secure non-volatile storage memory.

24. The medium in claim 19, wherein receiving the trigger comprises:
implementing at least one heuristic method of detecting unauthorized activity in the node.

25. The medium in claim 24, wherein the heuristic method comprises:
monitoring a number of unsuccessful login attempts to the node; and
generating the trigger when the number of unsuccessful login attempts exceeds a threshold.

26. The medium in claim 24, wherein the heuristic method comprises:
setting a timer that runs for a configurable interval in the node;
resetting and restarting the timer when contact is maintained between the node and the central authority; and
generating the trigger by the node when the timer expires.
